(19) United States
(12) Patent Application Publication
(10) Pub. No.: US 2025/0311825 A1
(43) Pub. Date: Oct. 9, 2025

(54) WATERPROOF BAG

(71) Applicant: PEGATRON CORPORATION, Taipei (TW)

(72) Inventor: Shun-Chieh CHANG, Taipei (TW)

(21) Appl. No.: 19/007,706

(22) Filed: Jan. 2, 2025

(30) Foreign Application Priority Data
Apr. 9, 2024 (TW) 113113173

(51) Int. Cl. A45C 15/00; A45C 3/10; A45C 11/00

(52) U.S. Cl. CPC A45C 15/00; A45C 3/10; A45C 11/003

(57) ABSTRACT

A waterproof bag is applicable to accommodating an electronic apparatus, and includes a bag body, a first and a second sound receiver, a first and a second sound generator, an acoustics module, and a connecting line. The first sound receiver is on an inner side of the bag body and is configured to receive an internal sound. The first sound generator is on an outer side of the bag body and is configured to play back the internal sound. The second sound receiver is on the outer side of the bag body and is configured to receive an external sound. The second sound generator is on the inner side of the bag body and is configured to play back the external sound. The acoustics module performs audio signal processing on the internal sound and the external sound. The electronic apparatus supplies power to the acoustics module through the connecting line.

### CROSS-REFERENCE TO RELATED APPLICATION

This application claims the priority benefit of Taiwan application serial no. 113113173, filed on Apr. 9, 2024. The entirety of the above-mentioned patent application is hereby incorporated by reference herein and made a part of this specification.

### TECHNICAL FIELD

The present disclosure relates to a waterproof bag, and in particular, to a waterproof bag with a microphone and a speaker inside and outside to transmit sound.

### BACKGROUND

A main purpose of a waterproof bag for an electronic apparatus on a market at present is waterproofing. When a user is going to an environment where the electronic apparatus is easily splashed or soaked in, to avoid a short circuit and damage to electronic components of the electronic apparatus (for example, a mobile phone or a tablet), the electronic apparatus will be placed in a waterproof bag to avoid soaking.

Especially, delivery personnel will also use waterproof bag on rainy days. However, if there is a need to make a call, the call quality will be greatly limited or even inaudible, and communication can only be performed by using text or wearing Bluetooth headphones, which may be more time-consuming or increase the use of additional devices.

### SUMMARY

In view of the above, the present disclosure provides a waterproof bag to be applicable to accommodating an electronic apparatus in an embodiment. The waterproof bag includes a bag body, a first sound receiver, a first sound generator, a second sound receiver, a second sound generator, an acoustics module, and a connecting line. The first sound receiver is arranged on an inner side of the bag body and is configured to receive an internal sound on the inner side of the bag body. The first sound generator is arranged on an outer side of the bag body and is configured to play back the internal sound. The second sound receiver is arranged on the outer side of the bag body and is configured to receive an external sound on the outer side of the bag body. The second sound generator is arranged on the inner side of the bag body and is configured to play back the external sound. The acoustics module is arranged on the bag body and is electrically connected to the first sound receiver, the first sound generator, the second sound receiver, and the second sound generator. The acoustics module is configured to perform audio signal processing on the internal sound and the external sound. The connecting line is arranged in the bag body, and is connected between the acoustics module and the electronic apparatus. The electronic apparatus supplies power to the acoustics module through the connecting line.

Thus, a sound emitted by the electronic apparatus in the waterproof bag may be received by the first sound receiver arranged on the inner side of the bag body, and is played back by the first sound generator arranged on the outer side of the bag body. A user can clearly hear the sound from the electronic apparatus. A sound made by the user outside the bag body may be received by the second sound receiver arranged on the outer side of the bag body, and then played back by the second sound generator arranged on the inner side of the bag body. In this way, the sound made by the user may be clearly received by the electronic apparatus in the bag body, so that a call can be made through the electronic apparatus. In this way, by respectively arranging the sound receivers and the sound generators on the inner side and the outer side of the waterproof bag, the electronic apparatus accommodated in the bag body to achieve a waterproof effect can still achieve good communication.

### BRIEF DESCRIPTION OF THE DRAWINGS

FIG. 1 is a three-dimensional view of a bag body according to an embodiment of the present disclosure.

FIG. 2 is a schematic decomposition view of an electronic apparatus assembled to a bag body according to an embodiment of the present disclosure.

FIG. 3 is a flowchart for performing audio signal processing and calculating on an internal sound according to an embodiment of the present disclosure.

FIG. 4 is a flowchart for performing audio signal processing and calculating on an external sound according to an embodiment of the present disclosure.

### DETAILED DESCRIPTION

Embodiments are proposed to describe in detail below. However, the embodiments are only used as examples for describing, and cannot limit the scope to be protected by the present disclosure. In addition, drawings in the embodiments omit part components to clearly display technical features of the present disclosure. The same reference numerals in all the drawings represent the same or similar components.

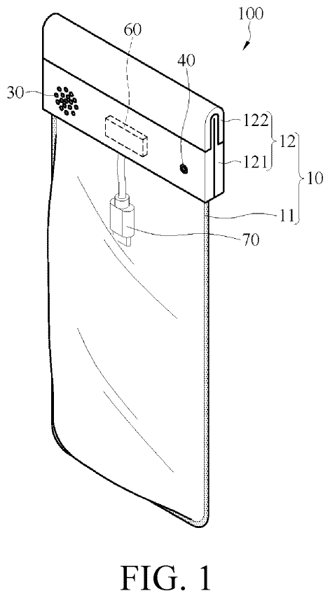

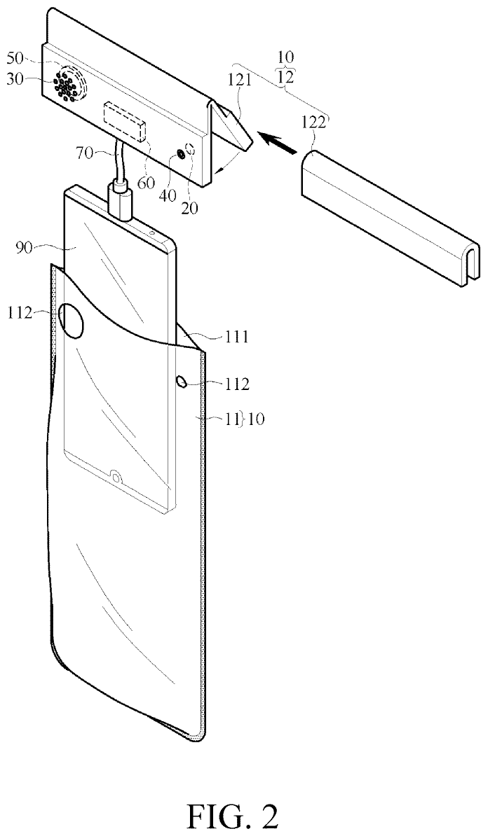

Please refer to FIG. 1 and FIG. 2 first. FIG. 1 is a three-dimensional view of a bag body according to an embodiment of the present disclosure. FIG. 2 is a schematic decomposition view of an electronic apparatus assembled to a bag body according to an embodiment of the present disclosure. A waterproof bag 100 of this embodiment is applicable to accommodating an electronic apparatus 90. The electronic apparatus 90 may be a mobile phone, a tablet or other electronic apparatus. The waterproof bag 100 includes a bag body 10, a first sound receiver 20, a first sound generator 30, a second sound receiver 40, a second sound generator 50, an acoustics module 60, and a connecting line 70.

A type of the bag body 10 may be formed by a plastic bag piece 11 and a sealing component 12 as illustrated in FIG. 1 and FIG. 2. In other implementations, the bag body may alternatively be in a zipper storage bag type formed by a single plastic bag body, a silicone bag body with a waterproof zipper, or the like.

In this embodiment, a shape and a size of the plastic bag piece 11 of the bag body 10 may adjusted as required, and the plastic bag piece 11 has at least one opening 111, so that the electronic apparatus 90 may be placed in through the opening 111. In addition, through holes 112 may respectively be formed in positions corresponding to the first sound receiver 20 and the second sound generator 50 on the plastic bag piece 11, so that the first sound receiver 20 may receive an internal sound on an inner side of the bag body 10, and the second sound generator 50 may play back an external sound to the inner side of the bag body 10 after the bag body 10 is assembled. The sealing component 12 may include a clamping piece 121 and a fastening piece 122. After the clamping piece 121 is clamped on the plastic bag piece 11 to seal the opening 111, the fastening piece 122 is arranged above on the clamping piece 121 in a sliding manner, so that an upper end of the sealing component 12 tightly seals the opening 111 to prevent a liquid from flowing in from the opening 111 to achieve a waterproof effect.

The first sound receiver 20 is arranged on the inner side of the bag body 10 and is configured to receive the internal sound on the inner side of the bag body 10. The first sound generator 30 is arranged on an outer side of the bag body 10 and is configured to play back the internal sound. The second sound receiver 40 is arranged on the outer side of the bag body 10 and is configured to receive the external sound on the outer side of the bag body 10. The second sound generator 50 is arranged on the inner side of the bag body 10 and is configured to play back the external sound. In this embodiment, the first sound receiver 20, the first sound generator 30, the second sound receiver 40, and the second sound generator 50 are illustrated by the sealing component 12 assembled on the bag body 10. It can be learned from FIG. 1 that the first sound generator 30 and the second sound receiver 40 are arranged in a direction towards the outer side on the clamping piece 121 of the sealing component 12. It can be learned from FIG. 2 that the first sound receiver 20 and the second sound generator 50 are arranged in a direction towards the inner side on the clamping piece 121 of the sealing component 12.

The first sound generator 30 arranged towards the outer side may be, for example, a waterproof speaker, has a certain waterproof grade (for example, IPX8). The second sound receiver 40 may be, for example, a microphone coated with a waterproof film (for example, a waterproof film with the waterproof grade of IPX8). In this way, a waterproof effect can be achieved even if the first sound generator 30 and the second sound receiver 40 are arranged on the outer side of the bag body 10. The first sound receiver 20 and the second sound generator 50 arranged towards the inner side of the bag body 10 are sealed on the inner side, so a waterproof speaker and a waterproof film may be applied on a microphone, or a general speaker and a microphone may also be used.

The acoustics module 60 is arranged on the bag body 10 and is electrically connected to the first sound receiver 20, the first sound generator 30, the second sound receiver 40, and the second sound generator 50. Electrical connections between the acoustics module 60 and various components may be achieved by wiring wires in an internal space or an inner side surface of the clamping piece 121. The acoustics module 60 may further include various control components or power supply components such as a control Integrated Circuit (IC) and a power supply IC. The acoustics module 60 is configured to perform audio signal processing on the internal sound and the external sound.

The connecting line 70 is arranged in the bag body 10, and is connected between the acoustics module 60 and the electronic apparatus 90. The electronic apparatus 90 supplies power to the acoustics module 60 through the connecting line 70 to supply power to the acoustics module 60, the first sound receiver 20, the first sound generator 30, the second sound receiver 40, and the second sound generator 50. Thus, large electronic components such as a battery may alternatively be omitted, the waterproof bag 100 can be simplified, and the manufacturing cost can be reduced.

In other implementations, when the bag body 10 is in a zipper storage bag type formed by a single plastic bag body, the first sound receiver 20, the first sound generator 30, the second sound receiver 40, and the second sound generator 50 may alternatively be directly assembled on the plastic bag body and face required directions. In a manner of forming a hole in the plastic bag body, the first sound generator 30 and the second sound receiver 40 on the outer side can be electrically connected to the acoustics module 60 positioned on the inner side.

Through the above structure, a sound emitted by the electronic apparatus 90 in the waterproof bag 100 may be received by the first sound receiver 20 arranged on the inner side of the bag body 10, and is played back by the first sound generator 30 arranged on the outer side of the bag body 10. A user can clearly hear the sound from the electronic apparatus 90. While a sound made by the user outside the bag body 10 may be received by the second sound receiver 40 arranged on the outer side of the bag body 10, and then is played back by the second sound generator 50 arranged on the inner side of the bag body 10. In this way, the sound made by the user may alternatively be clearly received by the electronic apparatus 90 in the bag body 10, so that a call is made through the electronic apparatus 90. In this way, by respectively arranging the sound receivers and the sound generators on the inner side and the outer side of the waterproof bag 100, when the electronic apparatus 90 is accommodated in the bag body 10 and is sealed to achieve a waterproof effect, communication without obstruction can be performed.

In addition, in this embodiment, the first sound generator 30 and the second sound generator 50 are correspondingly arranged on the inner side and the outer side of the same position of the bag body 10. The first sound receiver 20 and the second sound receiver 40 are correspondingly arranged on the inner side and the outer side of the same position of the bag body 10. The first sound receiver 20 and the second sound generator 50 are respectively arranged on two ends relatively far away from each other on the same side of the bag body 10, and the second sound receiver 40 and the first sound generator 30 are respectively arranged on two ends relatively far away from each other on the same side of the bag body 10.

Thus, the sound receivers and the sound generators are arranged as far away from each other as possible, so that direct impacts of the sound generators during emitting sounds on the sound receivers can be reduced, and meanwhile, an echo effect is avoided.

Further, as described above, the acoustics module 60, the first sound receiver 20, the first sound generator 30, the second sound receiver 40, and the second sound generator 50 are all arranged at an end with an opening 111 of the bag body 10. All electronic components are arranged in the same end in a direction of a long axis of the bag body 10, so that wiring distance required for the electrical connections between various electronic components can be reduced, and power consumption caused by long distance between the various electronic components can be avoided.

In an actual operation, the waterproof bag 100 may be used simply as a general waterproof bag 100. When the electronic apparatus 90 is placed in the bag body 10 without plugging the connecting line 70, power cannot be supplied to the acoustics module 60 through the connecting line 70, so that the acoustics module 60, the first sound receiver 20, the first sound generator 30, the second sound receiver 40, and the second sound generator 50 will not function. After the connecting line 70 is plugged in the electronic apparatus 90, the power required by the electronic components may be supplied.

In some other embodiments, the waterproof bag 100 may include a battery (not shown) connected to the acoustics module 60, so that power is supplied to the acoustics module 60 through the battery to provide the power required by the acoustics module 60, the first sound receiver 20, the first sound generator 30, the second sound receiver 40, and the second sound generator 50. In this way, the connecting line 70 is not needed.

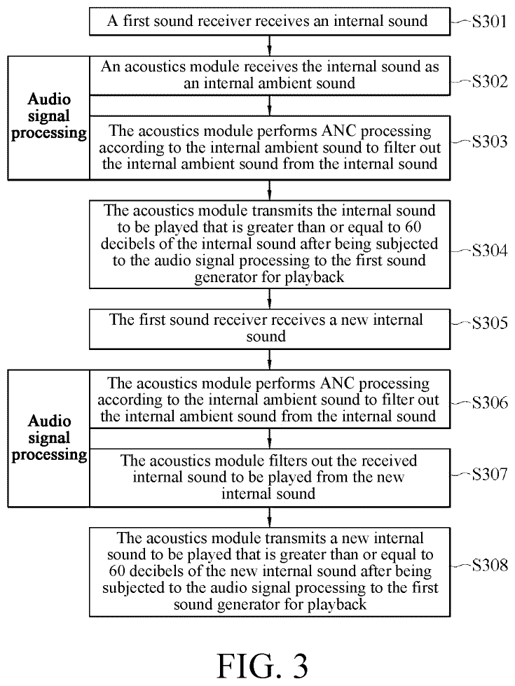

Next, please refer to FIG. 3, which is a flowchart for performing audio signal processing and calculating on an internal sound according to an embodiment of the present disclosure. Audio signal processing and calculating of an internal sound and an external sound of the bag body 10 in an operating mode are respectively described in the following. When the electronic apparatus 90 inside the bag body 10 emits a sound, the acoustics module 60 receives an internal sound received by the first sound receiver 20 (S301), performs audio signal processing on the internal sound (S302 and S303), and transmits the internal sound to be played that is greater than or equal to 60 decibels of the processed internal sound to the first sound generator 30 for playback (S304). The internal sound includes an internal ambient sound. The acoustics module 60 is configured to perform the audio signal processing on the internal sound to filter out the internal ambient sound from the internal sound.

In detail, the first sound receiver 20 is set to be capable of receiving a sound between 100 and 8000 Hz. The audio signal processing includes collecting an internal sound on the inner side of the bag body 10 through the first sound receiver 20 (S301) and transmitting to the acoustics module 60 when the electronic apparatus 90 does not emit a sound (for example, when the electronic apparatus 90 is just connected to the acoustics module 60 through the connecting line 70). At this moment, the collected internal sound will only include an internal ambient sound capable of being received on the inner side of the bag body 10. The internal ambient sound is not limited to noise generated by friction, collision, and the like on the inner side of the bag body 10, or may be noise received after penetrating from environment on the outer side to the inner side. Therefore, in step S302, the acoustics module 60 receives the internal sound as the internal ambient sound. Next, in step S303, the acoustics module 60 performs Active Noise Cancellation (ANC) processing according to the internal ambient sound to filter out the internal ambient sound from the internal sound, so as to reduce an impact of the noise on the inner side or the outer side of the bag body 10 on the sound emitted from the electronic apparatus 90.

Further, when the first sound generator 30 plays the internal sound to be played, the internal sound to be played will be inevitably received by the second sound receiver 40 arranged on the outer side. In addition, the internal sound to be played may alternatively be received by the first sound receiver 20 positioned on the inner side of the bag body 10 when volume is high. In detail, after the first sound generator 30 plays the internal sound to be played, as shown in step S305, the first sound receiver 20 positioned on the inner side of the bag body 10 will receive a new internal sound, and the second sound receiver 40 will receive a new external sound. At this moment, to avoid replaying the previously played internal sound to be played to cause an echo effect, the acoustics module 60 will perform the audio signal processing on the new internal sound that is newly received (S306 and S307).

FIG. 3 shows an audio signal for a purpose of simplifying description and adding a sequential relationship to understand processing. Steps S305 to S307 are described by taking the internal sound to be played and the internal ambient sound received by the first sound receiver 20 as the new internal sound that is newly received. Actually, the electronic apparatus 90 may alternatively emit a sound when the internal sound to be played is played back. Therefore, the first sound receiver 20 may alternatively simultaneously receive the internal sound to be played, the internal ambient sound, and the sound emitted from the electronic apparatus 90 to form a new internal sound.

In detail, in step S306, after the new internal sound is transmitted to the acoustics module 60, the acoustics module 60 will perform audio signal processing of filtering out the internal ambient sound first. Then, step S307 is performed, and the acoustics module 60 filters out the received internal sound to be played from the new internal sound. Thus, after the acoustics module 60 performs audio signal processing, the acoustics module 60 can distinguish that the sound played back by the first sound generator 30 on the outer side of the bag body 10 is repeatedly received, and eliminates the sound o avoid problems that the first sound receiver 20 on the inner side of the bag body 10 receives the sound by mistake and plays back the sound repeatedly. When the new internal sound only includes the internal sound to be played and the internal ambient sound, once the internal sound to be played and the internal ambient sound are filtered out, there will be no sound for playback in step S307. However, if the new internal sound includes the internal sound to be played, the internal ambient sound, and the sound emitted from the electronic apparatus 90, the internal sound to be played and the internal ambient sound can be filtered out, and then the remaining sound emitted from the electronic apparatus 90 is calculated as a new internal sound to be played and the new internal sound to be played is transmitted to the first sound generator 30 for playback, as shown in step S308.

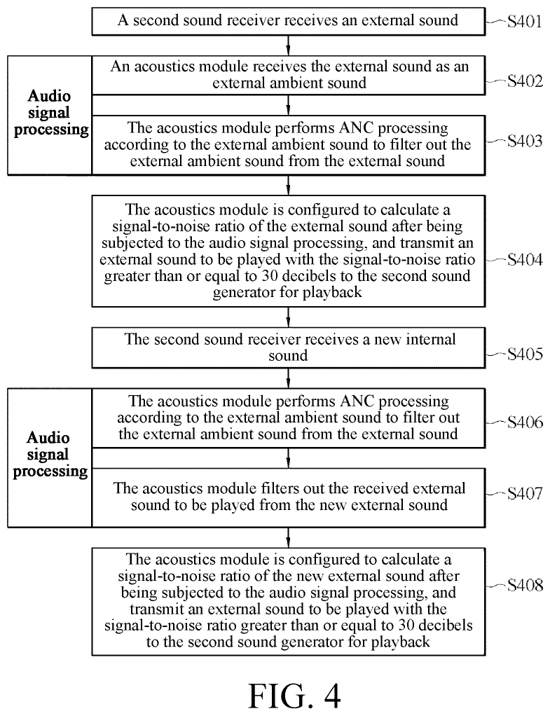

Next, please refer to FIG. 4, which is a flowchart for performing audio signal processing and calculating on an external sound according to an embodiment of the present disclosure. For a sound on the outer side of the bag body 10, after the second sound receiver 40 receives an external sound (S401) and performs audio signal processing (S402 and S403), the acoustics module 60 may be further configured to calculate a signal-to-noise ratio of the external sound after being subjected to the audio signal processing, and transmit the external sound with the signal-to-noise ratio greater than or equal to 30 decibels to the second sound generator 50 for playback (S404). The external sound includes an external ambient sound. The acoustics module 60 is configured to perform the audio signal processing on the external sound to filter out the external ambient sound from the external sound. Further, the environment on the outer side of the bag body 10 is open and changes in the environment where a user is positioned are difficult to predict, so an audio signal to be played may be distinguished by determining the signal-to-noise ratio of the external sound.

For the external sound, the audio signal processing includes receiving the external sound on the outer side of the bag body 10 through the second sound receiver 40 (S401) and transmitting the external sound to the acoustics module 60 when the electronic apparatus 90 is just connected to the connecting line 70 to supply power to the acoustics module 60 and when the user does not make a sound. At this moment, the collected external sound will only include the external ambient sound that is capable of being received on the outer side of the bag body 10. The acoustics module 60 receives the external sound as the external ambient sound (S402). The acoustics module 60 performs ANC processing according to the external ambient sound to filter out the external ambient sound from the external sound (S403), so as to reduce an impact of the noise on the outer side of the bag body 10 on the sound received by the second sound receiver 40. As described previously, the environment on the outer side of the bag body 10 is open and changes in the environment where a user is positioned are difficult to predict, after the second sound receiver 40 out of the bag body 10 collects the external sound, filtering processing is performed by taking the current external sound as the external ambient sound, noise can be reduced, and the audio signal to be played can be ensured to be received.

Further, when the second sound generator 50 plays back the external sound to be played, the external sound to be played will be inevitably received by the first sound receiver 20 arranged on the inner side. In addition, the external sound to be played may alternatively be received by the second sound receiver 40 positioned on the outer side of the bag body 10. After the second sound generator 50 plays back the external sound to be played, as shown in step S405, the second sound receiver 40 positioned on the outer side of the bag body 10 takes the received external sound to be played as a new external sound. At this moment, to avoid replaying the previously played external sound to be played to cause an echo effect, the acoustics module 60 will perform the audio signal processing on the new external sound that is newly received (S406 and S407).

FIG. 4 shows an audio signal for a purpose of simplifying description and adding a sequential relationship to understand processing. Steps S405 to S407 are described by taking the external sound to be played and the external ambient sound received by the second sound receiver 40 as the new external sound newly received. Actually, the user may alternatively make a sound synchronously when the external sound to be played is played back. Therefore, the second sound receiver 40 may alternatively simultaneously receive the external sound to be played, the external ambient sound, and the sound made by the user to form a new external sound that is newly received.

In detail, in step S406, after the new external sound is transmitted to the acoustics module 60, the acoustics module 60 similarly performs the audio signal processing of filtering out the external ambient sound first. Then, step S407 is performed, and the acoustics module 60 filters out the received external sound to be played from the new external sound. Thus, after the acoustics module 60 performs the audio signal processing, it may be distinguished that the sound played back by the second sound generator 50 on the inner side of the bag body 10 is repeatedly received, and the sound is eliminated to avoid problems that the second sound receiver 40 on the outer side of the bag body 10 receives the sound by mistake and plays back the sound repeatedly. When the new external sound only has the external sound to be played and the external ambient sound, and once the external sound to be played and the external ambient sound are filtered out, there will be no sound for playback in step S407. However, if the new external sound includes the external sound to be played, the external ambient sound, and the sound made by the user, the external ambient sound and the external sound to be played can be filtered out, and then the remaining sound made by the user is calculated as a new external sound to be played and the new sound to be played is transmitted to the second sound generator 50 for playback, as shown in step S408.

In conclusion, the sound receivers and the sound generators are respectively arranged on the inner side and the outer side of the waterproof bag 100. When the electronic apparatus 90 is accommodated in the bag body 10 and is sealed to achieve a waterproof effect, communication without obstruction can be performed.

What is claimed is:

1. A waterproof bag, applicable to accommodating an electronic apparatus, the waterproof bag comprising:
a bag body;
a first sound receiver, arranged on an inner side of the bag body and configured to receive an internal sound on an inner side of the bag body;
a first sound generator, arranged on an outer side of the bag body and configured to play back the internal sound;
a second sound receiver, arranged on an outer side of the bag body and configured to receive an external sound on an outer side of the bag body;
a second sound generator, arranged on an inner side of the bag body and configured to play back the external sound;
an acoustics module, arranged on the bag body and electrically connected to the first sound receiver, the first sound generator, the second sound receiver, and the second sound generator, wherein the acoustics module is configured to perform audio signal processing on the internal sound and the external sound; and
a connecting line, arranged in the bag body, and connected between the acoustics module and the electronic apparatus, wherein the electronic apparatus supplies power to the acoustics module through the connecting line.

2. The waterproof bag according to claim 1, wherein the first sound generator and the second sound generator are correspondingly arranged on the inner side and the outer side of the same position of the bag body.

3. The waterproof bag according to claim 1, wherein the first sound receiver and the second sound receiver are correspondingly arranged on the inner side and the outer side of the same position of the bag body.

4. The waterproof bag according to claim 1, wherein the first sound receiver and the second sound generator are respectively arranged on two ends relatively away from each other on the same side of the bag body, and the second sound receiver and the first sound generator are respectively arranged on two ends relatively away from each other on the same side of the bag body.

5. The waterproof bag according to claim 1, wherein the acoustics module, the first sound receiver, the first sound generator, the second sound receiver, and the second sound generator are all arranged at an opening of the bag body.

6. The waterproof bag according to claim 1, wherein the internal sound comprises an internal ambient sound; and the acoustics module is configured to perform the audio signal processing on the internal sound to filter out the internal ambient sound from the internal sound.

7. The waterproof bag according to claim 1, wherein the acoustics module transmits an internal sound to be played that is greater than or equal to 60 decibels of the internal sound after being subjected to the audio signal processing to the first sound generator for playback.

8. The waterproof bag according to claim 7, wherein after the first sound receiver receives the internal sound to be played that is played back by the first sound generator, the acoustics module filters out the received internal sound to be played from the internal sound.

9. The waterproof bag according to claim 1, wherein the external sound comprises an external ambient sound; and the acoustics module is configured to perform the audio signal processing on the external sound to filter out the external ambient sound from the external sound.

10. The waterproof bag according external claim 1, wherein the acoustics module is further configured to calculate a signal-to-noise ratio of the external sound after being subjected to the audio signal processing, and transmit an external sound to be played with the signal-to-noise ratio greater than or equal to 30 decibels to the second sound generator for playback.

11. The waterproof bag according to claim 10, wherein after the second sound receiver receives the external sound to be played that is played back by the second sound generator, the acoustics module filters out the received external sound to be played from the external sound.
